(19) United States
(12) Patent Application Publication
(10) Pub. No.: US 2026/0135418 A1
(43) Pub. Date: May 14, 2026

(54) Electromagnetic Machine

(71) Applicant: Dennis Majoe, Eastleigh, Hampshire (GB)

(72) Inventor: Dennis Majoe, Eastleigh, Hampshire (GB)

(21) Appl. No.: 19/120,029

(22) PCT Filed: Oct. 11, 2023
(86) PCT No.: PCT/EP2023/078231

§ 371 Date: Apr. 10, 2025

(30) Foreign Application Priority Data
Oct. 11, 2022 (GB) 2214944.7

(51) Int. Cl. H02K 1/14; H02K 1/278; H02K 3/46

(52) U.S. Cl. CPC H02K 1/141; H02K 1/148; H02K 1/278; H02K 3/46; H02K 2201/12; H02K 2203/12

(57) ABSTRACT

A 3-phase motor, which includes: (i) a rotor with four or more magnets arranged in sequence in alternatingly opposed orientation with a pitch at least substantially three times their polar length, wherein the rotor spins about an axis such that the magnets follow a toroidal path; and (ii) a stator having at least 3 windings, wherein for each winding first and second shaped portions thereof extend substantially transverse to and adjacent to the toroidal path, wherein the first and second shaped parts of each winding induce oppositely directed magnetic fields in or around the toroidal path to act on, respectively, the alternatingly opposed adjacent magnets; the pitch of the first and second shaped parts is substantially the same as the pitch of the magnets; and each of the 3 windings is for connection to a different phase of a 3-phase power supply.

### INTRODUCTION

The present invention relates to an electromagnetic machine, in particular a motor, especially for a drone.

### BACKGROUND TO THE INVENTION

A permanent magnet circumferential flux motor is one in which the magnetic flux tends to act both radially and then axially. A known such motor is described in WO 2019/166833, in which the pitch of magnets on its rotor is at least double their polar length (or at least a multiple of the polar length) and the pitch of shaped parts of stator windings is equal to their polar length.

There remains, however, a need for ever more efficient and/or powerful such motors, e.g. to carry increased loads, and/or to carry loads over longer distances using drones incorporating such a motor.

Many electromagnetic machines can be operated either as motors to produce power by providing them with current or as generators by providing them with power to produce current.

The object of the present invention is to provide to provide an improved electromagnetic machine. An object of specific embodiments of the invention is to provide an alternative motor, in particular an alternative and preferably improved 3-phase motor.

### SUMMARY OF THE INVENTION

According to the invention there is provided a 3-phase electromagnetic machine comprising:
a rotary portion comprising four or more magnets arranged in sequence in alternatingly opposed orientation with a pitch at least substantially three times their polar length, wherein the rotary portion is able to spin about an axis such that the magnets follow a toroidal path; and
a stationary portion having at least 3 windings, wherein for each winding first and second shaped portions thereof extend substantially transverse to and adjacent to the toroidal path,
   wherein
the first and second shaped parts of each winding induce oppositely directed magnetic fields in or around the toroidal path to act on, respectively, alternatingly opposed adjacent magnets;
the pitch of the first and second shaped parts is substantially the same as the pitch of the magnets;
each of the 3 windings is for connection to a different phase of a 3-phase power supply; and
the 3 windings are staggered around the toroidal path so as to act successively on the magnets.

Machines of the invention are preferably 3-phase motors. They can be used as motors for flying drones, powered by 3-phase power from one or more DC batteries. Suitably, in operation, DC power is switched by an electronic controller to the windings in turn, as is conventional in brushless DC motors. The invention thus provides a 3-phase motor, having benefits over single phase motors such as constant drive and the ability to define direction of rotation regardless of shaft angle. The invention also provides a drone comprising a motor of the invention.

As used herein:
a magnet's “pole” is that point or face from which magnetic field lines are deemed to emanate in the case of the magnet's North pole and to which they are deemed to return in the case of the South pole;
a magnet's “polar axis” is the line between its North and South poles;
a magnet's “polar length” refers to the distance between its North and South poles, and hence generally refers to the total magnet length, between respective end faces. Preferred magnets for the invention are substantially cylindrically shaped;
a pair of magnets are said to have the same “orientation” if their polar axes are aligned and their adjacent poles are the North pole of one and the South pole of the next, whereby they attract each other when close enough; the orientation is opposed if their adjacent poles are the North pole of one and the North pole of the next, or the South pole of one and the South pole of the next, etc;
a definition herein refers to the “alternatingly opposed orientation” of the magnets, and this might otherwise be described as simply an “alternating orientation”, meaning the poles are NS SN NS SN, etc.
the “stationary portion” of an electromagnetic machine is that portion which remains stationary, even though the entire machine including the stationary portion may move as a whole. The stationary portion will normally be a stator, this being a term used in respect of both rotary and linear machines;
the “moving portion” of an electromagnetic machine is that portion which moves in use with respect to the stationary portion. In a rotary machine, the moving portion is normally referred to as the “rotor” or as the “rotary portion”. No term separate from moving portion is used herein for a linear motor;
the term “magnet” is intended to comprise both permanent magnets, electromagnets, and parts in which magnetism is induced, unless the context clearly indicates only one type of magnet; preferred magnets for the invention are permanent magnets;
reference to the “pitch” of the magnets on the moving portion refers, when the moving portion is a rotor, to the separation of the magnets if located on a line substantially at a tangent to the rotor. Thus a pitch of three indicates a length of three times the length of a single magnet.

A particular embodiment of the invention is a 3-phase motor comprising:
a rotor comprising four or more magnets arranged in sequence in alternatingly opposed orientation with a pitch at least substantially three times their polar length, wherein the rotor is able to spin about an axis such that the magnets follow a toroidal path; and
a stator having at least 3 windings, wherein for each winding first and second shaped portions thereof extend substantially transverse to and adjacent to the toroidal path,
   wherein
the first and second shaped parts of each winding induce oppositely directed magnetic fields in or around the toroidal path to act on, respectively, the alternatingly opposed adjacent magnets;
the pitch of the first and second shaped parts is substantially the same as the pitch of the magnets;
each of the 3 windings is for connection to a different phase of a 3-phase power supply; and
the 3 windings are staggered around the toroidal path so as to act successively on the magnets.

Embodiments of the invention include a motor of the invention electrically connected to a DC power supply. Preferably, power to the windings is switched by an electronic controller, and the controller preferably can adjust the phase and amplitude of the DC current to control the speed and torque of the motor.

The pitch of the magnets is preferably substantially three times their polar length. Hence, preferably, the distance between one end of a magnet and the end of the adjacent magnet is substantially 2 magnet lengths. As will be appreciated for magnets spaced around the circumference of a rotor the distance is measured along that circumference.

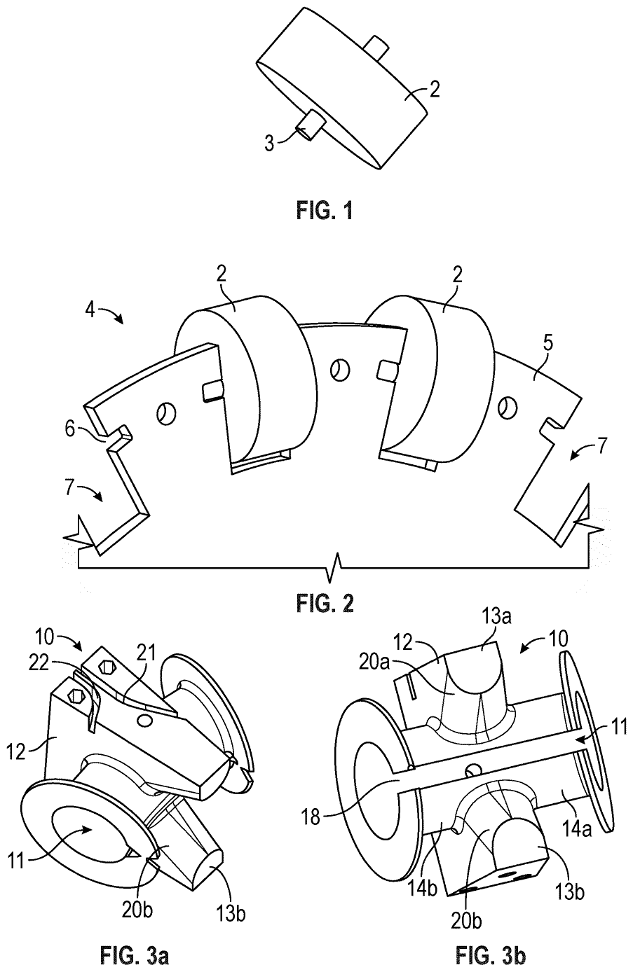

The magnets for use in the invention can in general be of any shape, however it is found that cylindrical magnets such as in the examples are practical. The magnets, and their polar axes, can be curved complementarily to the curvature of the toroidal path. Magnets that are sections of a toroid may be used. Cylindrical wedge-shaped magnets (i.e. in which front and rear faces converge, e.g. at the centre of the rotor) have also been used. The magnet is typically included with a means to hold/fix it to the rotor; in the example, FIG. 1 shows a non-ferrous pin/cylinder in the centre of the magnet, but other attachments of the magnet to the rotor body are possible.

For the 3-phase motor of the invention, the spacing between the magnets is hence suitably at least twice the magnet length (magnet, space, space, magnet, etc), and preferably substantially twice the magnet length. The spacing is preferably the same all the way around the circumference of the rotor. The spacing between the shaped winding parts of the rotor driving coils is preferably the same as the spacing between the magnets, so that when e.g. in a stationary position the two shaped winding parts of a given coil align with two magnets, usually with adjacent magnets.

The spacing between the magnets is preferably twice the magnet length. For cylindrical magnets, not being wedge-shaped, located on the rotor circumference each magnet cannot be this distance away from each other over its entire face. Reference to spacing refers, therefore, to the spacing between the centre points of adjacent magnets, e.g. axially in line with the location of the through-pin used for mounting the magnets on the rotor. So, as illustrated in the example below, the magnets are further apart towards the outer portion of their face and closer on the inner portions of their faces, towards the centre of the rotor.

In this context, the term “inner” means towards the centre of the moving portion. In contrast, the term “outer” means towards the circumference of the moving portion.

The magnets have north and south pole faces. The magnets are placed so that any pole face is adjacent to the same pole, so the poles run north north, south south, north north etc. around the circumference of the moving portion.

Stationary portion windings are suitably coils. Embodiments of the invention comprise (for each winding/coil) a coil holder, also referred to as a former. The coil holder is used to assist and/or support the coils. The coils are generally made of copper though other options exist, such as aluminium. The coil holder can be used in full or in part to wind the coil and hold it in place and is conveniently used to assist in supporting and holding/positioning the two shaped parts of the coils in the motor relative to the magnets and neighbouring coils. Optionally, no coil holder is used in the motor, in which case the coil may be formed/shaped and then heated or otherwise treated so as to form or set as a unit, e.g. one solid entity. The coil holder can then be removed. Preferably the coil holder is plastic (made of plastic material) and relatively thin and light so there is no particular need or advantage to removing it even if the coil is fairly stable.

In embodiments of the invention, e.g. as illustrated in the example below, three coil holders or coils are used to drive at least four magnets or an even number of magnets great than four or a multiple of four e.g. eight, twelve, or sixteen magnets etc. Two 3-phase coil arrangements can drive eight magnets or sixteen etc. Three 3-phase arrangements can drive twelve magnets etc. Four 3-phase arrangements can drive sixteen magnets etc. Eight 3-phase arrangements can drive 32 magnets etc. In the specific example below, 3 coil holders are used with a rotor having sixteen magnets.

Further embodiments of the invention comprise more than one stator (which can also be referred to as more than one set of stator windings, 3 windings per stator).

In these embodiments, the respective stators can be in phase with each other, i.e. each winding of a stator is in phase with a corresponding winding of another stator. They can also be shifted out-of-phase. For the out-of-phase embodiments, suitably each winding of a given stator is out of phase with the other windings of that stator and is also out of phase with the windings of another stator. A motor of the invention with 2 stators out-of-phase may be referred to as a 6-phase motor. A motor of the invention with 3 stators out-of-phase may be referred to as a 9-phase motor (i.e. all 9 windings of the 3 stators are out-of-phase). Reference to a 3-phase motor is intended to refer to a motor including a 3-phase motor, and therefore includes motors with multiple stairs, such as 6-phase motors, 9-phase motors, etc

In embodiments of the invention comprising multiple stators these may be powered by the same, single DC power supply or may be powered by a separate power supply, each with its own battery, per stator.

As per the example, magnets are preferably evenly spaced around the rotor, and the pitch of the first and second shaped parts of a given coil/winding is very closely, preferably exactly, the same as the pitch of the magnets. This has the result that as the rotor turns and the magnets move, these first and second parts of the coil/winding can align very closely, preferably exactly, with 2 (usually adjacent) magnets on the rotor.

The 3-phase motor of the invention requires at least three wound coils, suitably on coil holders. Coil holders shown in the example comprise a body having two side arms and a middle wedge-shaped section. Two shaped winding parts of the coils are held on the arms, outside the middle section and within outer retainers, such as flanges. The shape and size and spacings of the coil holder components and, as a result, the held, shaped winding parts of the coils are such that when the magnets are inside the coil holder, e.g. an inner toroidal C-section of the coil holder shown in the example below, then one magnet is covered by/aligned with one winding part of the coil and the adjacent magnet is covered by/aligned with the other winding part of the coil. Meanwhile the wedge-shaped central section separates the respective shaped parts of the winding to the same extent the magnets are separated, thus typically approximately twice the cylinder length of the magnet; approximately, in the sense the midpoints of the magnet faces are apart by approximately twice the individual magnet length.

It is preferred that the respective three wound coils, also referred to as windings, are staggered around the circumference of the rotor. The stagger is preferably one third the pitch of the magnets. The stagger is such that if the first and second shaped parts of one winding are aligned with adjacent magnets then the first and second shaped parts of the other two windings are not aligned with other magnets. Typically, once a given winding is thus aligned with its magnets (usually 2 adjacent magnets), the stagger of the 3 sets of windings means the other 2 windings are not aligned with any of the other magnets. As the rotor rotates and those mentioned 2 adjacent magnets move out of alignment with that given winding so magnets (again, usually adjacent) move into alignment with another, e.g. second, winding; then in turn as the rotor continues to rotate so magnets move into alignment with another different, e.g. third, winding. Motors of the invention are to be powered by switched DC power. Power switching between the 3 windings drives the motor as the magnets successively are aligned with the respective 3 windings.

Preferably:
the rotor has:
   an at least notional plane to which it is parallel, and
   the four or more magnets mounted on the rotor, with:
      their polar axes at least substantially in the plane and arranged tangentially to a circular path, and
      their transverse cross-section defining a surface of revolution, and
the stator comprises three or more formers (or a compound former of three sub-formers) with a cross-sectional shape following along or around the circular path and being complementary to and spaced radially from the said surface of revolution, the stator having windings each of which has a segment, or plurality of segments connected in series, each segment having:
   a first shaped part lying or wound onto a cross-sectional shape of the former, and
   a second shaped part also lying or wound onto a cross-sectional shape of the former,
the arrangement being such that a magnetic field induced by a current in the winding in the first and second shaped parts of the winding acts on the magnets.

Hence, the coil or winding of the first and second shaped parts are transverse to the direction of the magnets rotating on the rotor. Normally the winding has multiple loops or coils looping around the former as described in more detail in the example below.

The motor generally also comprises:
means for sensing the position of the magnets relative to the windings and
means for applying current to the windings, the current applying means alternating supply of power from its 3-phases to the respective windings in accordance with the sensed magnet/winding position.

The sensing means can comprise Hall Effect sensors suitably positioned with respect to the magnets' relative position with the coils, to time the current applying means. Alternatively, optical sensors can be used, with the timing marks, e.g. painted black and white timing marks, applied to the magnets. A further option is to sense the position of rotating magnets by measuring and applying algorithms to the back emf created by the magnets passing the coils e.g. detecting point(s) of zero crossing or anticipated zero crossing and using detection of these points to trigger switching of power to respective windings or sets of winding.

The rotor can be skeletal or a disc.

The magnets are normally permanent, but they can be electromagnets, with slip rings being provided via which they can be energised. It is also envisaged that the magnets can have their magnetism induced by the current in the winding, as in an induction motor. In the case of a rotary machine, the magnets are preferably arranged with their polar axes on a central plane of the rotor. However they can be arranged to one side of a rotor disc, particularly where a second set of magnets is arranged on the other side in a second toroidal space with a second winding.

The magnets can be solid in that their polar axes pass through their bodies. Alternatively, they can be hollow, with their axes passing down their central void. Whilst this latter arrangement may have little effect on torque, the resultant motor can be lighter.

### EXAMPLE

The invention is now illustrated in a specific example of a motor, with reference to the accompanying drawings in which:

FIG. 1 shows a schematic perspective view of a cylindrical magnet for use in the invention;

FIG. 2 shows a schematic cut-away perspective view of a rotor of the invention showing two magnets mounted on the rotor;

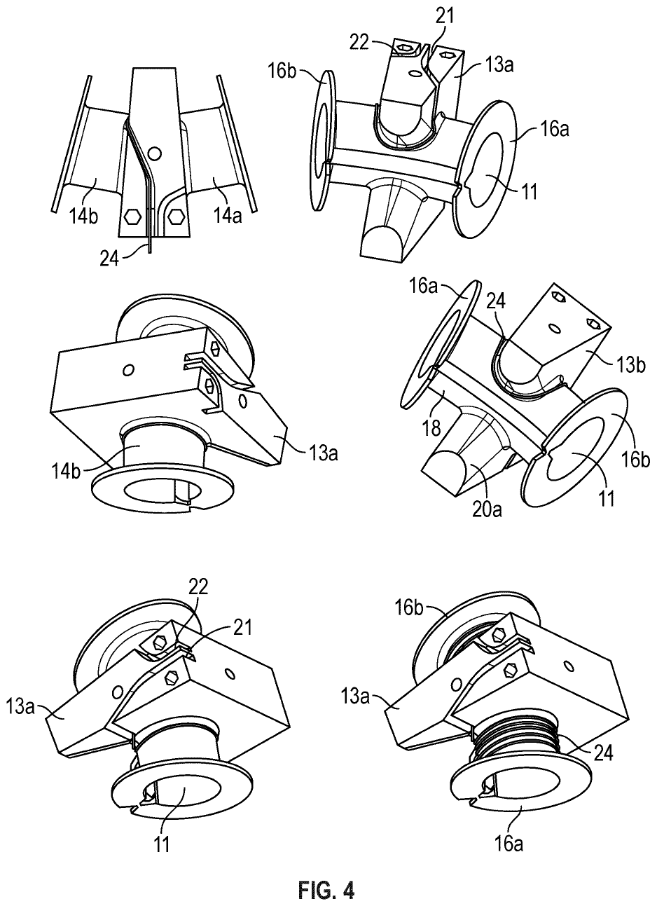

FIG. 3a and FIG. 3b show schematic perspective views of a former of the invention in two different orientations;

FIG. 4 shows schematic perspective views of the former of FIGS. 3a and 3b, in six different orientations and showing a partial coil winding thereon;

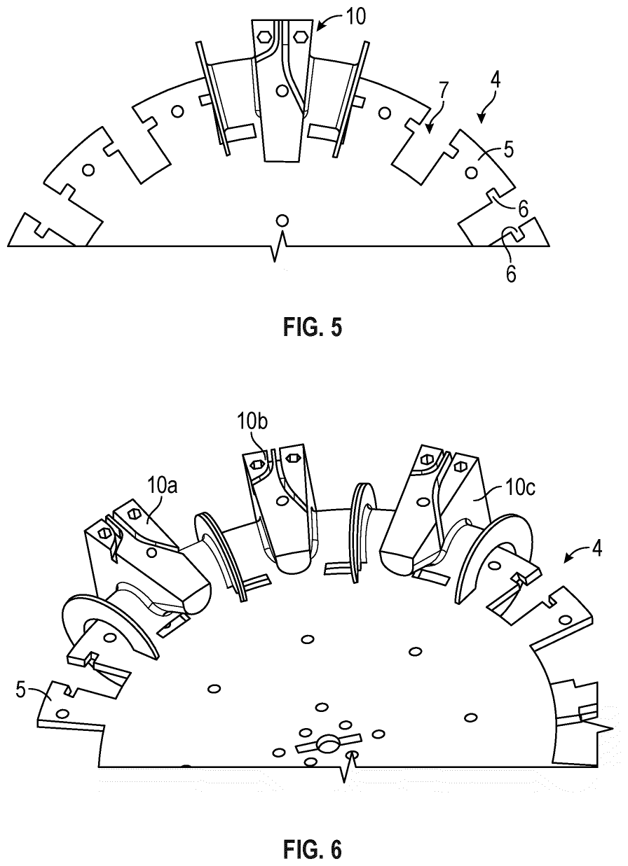

FIG. 5 shows a schematic cut-away plan view of a rotor of the invention plus one former;

FIG. 6 shows a schematic cut-away perspective view of the rotor of FIG. 5 plus three formers;

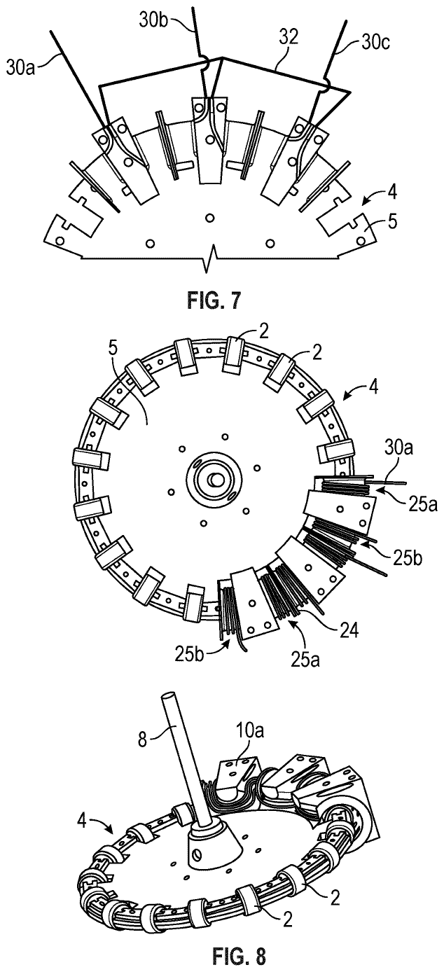

FIG. 7 shows a schematic cut-away plan view of a rotor of the invention plus three formers plus a schematic representation of the 3-phase power connection thereto; and

FIG. 8 shows plan and perspective views of the rotor of the invention with additional turns in the windings.

Referring to the figures, FIG. 1 shows a perspective view of a cylindrical magnet 2 mounted on through-pin 3. Re FIG. 2, sixteen of such magnets 2 are mounted one-by-one (only two are shown) around the circumference of a rotor 4 having a rotor body 5 with the magnets being attached to and held via their through-pins on pin mountings 6, the magnets 2 then being held within magnet holders 7 around the circumference of the body 5.

The rotor 4 is mounted on a shaft 8 (not shown in FIG. 1, seen in FIG. 8). The rotor body 5 is fast with the shaft and at right angles to it, whereby it rotates without wobble. At the circumference of the rotor body disc a plurality of the cylindrical permanent magnets 2 (not all shown) are held all at the same radial distance from the shaft to their polar axes, all being tangential to the disc at their mid-point, with their polar axes in the central plane of the disc and the midpoints of the axes on the circumference of the rotor body 5, and all being equally spaced around the body with an angular pitch equal to three times their polar length.

A coil winding (not shown in all Figures and only partially shown in some) is wound around formers 10a, 10b, and 10c, also indicated generally as 10 in FIG. 3a and FIG. 3b. Each former 10 comprises a former body 12 having upper 13a and lower 13b body portions, slightly wedge-shaped in cross section from above. Former 10 is shown in a multiple of different orientations in FIGS. 3a and 3b and also in FIG. 4. Again, referring generally to each former 10, extending from the body 12 are curved tubular side arms 14a and 14b. These arms are approximately C-section in shape when viewed from the side (see FIG. 3b), and are curved, defining a truncated or frusto-toroidal inner space 11. As the rotor 4 spins on its axis/shaft (not shown) the rotating magnets 2 define a toroid or toroidal space, also referred to as a surface of revolution, located centrally within the toroidal inner space 11 of the formers.

The open side of the C-sectioned formers defines a rotor slot 18 (see FIG. 3b; the orientation of FIG. 3a hides the slot) within which the rotor body rotates, the magnets rotating within the toroidal inner space 11 of the formers.

Upper 20a and lower 20b lugs are provided on, respectively, the upper 13a and lower 13b body portions of the former, and it is around these lugs and the former side arms that each coil is repeatedly wound to form the two shaped (sometimes referred to as right and left, respectively) winding parts of the coil for the motor. The shaped parts of the winding are retained on the former and restricted to a space defined between the upper and lower portions 13a and 13b by of the wedge-shaped body 12 in the centre and by end flanges 16a and 16b (see FIG. 4) at the outer ends of the side arms 14a and 14b. The restricted width of each shaped portion of the windings is approximately the width of a magnet.

Referring specifically to FIG. 4, a coil winding is shown progressing from an initial single strand of the coil in the top left-hand corner of FIG. 4 to a multi-strand partially wound coil in the bottom right-hand corner. The winding 24 begins via winding entry channel 21, around the upper lug 20a, next partially around the side arm 14b, then around the lower lug 20b and back around the side arm 14b, then repeating this winding pattern until a winding of multiple repeat turns or loops is built up, the bottom right-hand drawing in FIG. 4 showing a partially built-up winding. In the finished winding there are more turns/loops around the former arms and lugs. As will be appreciated, the winding does not traverse slot 18 as this is the slot in which the rotor body rotates/is located. When the winding has been completed it then forms left- and right-hand side shaped winding parts (see FIG. 8 and description thereof for detail), wound respectively around the left and right tubular side arms 14a and 14b. These shaped winding parts are spaced apart by the dimensions of the former body so that their separation is the same as the pitch of the magnets on the rotor; thus, with the rotor in the right position each aligns with one of the adjacent magnets mounted on the rotor body.

FIG. 5 shows a single former 10 in position around the rotor body, with magnets and other formers removed for ease of understanding. FIG. 6 then shows the next step in assembling the motor, with three formers 10a, 10b, and 10c mounted next to each other, again around the rotor body 5 and with magnets at the sides removed for ease of understanding. The spacing of the shaped winding parts on each of the formers 10a, 10b, and 10c with respect to the magnets 2 (not shown) in FIG. 6 is such that if the two (right and left) shaped winding parts of former 10a are aligned with adjacent magnets then the two shaped winding parts of formers 10b and 10c are not aligned with magnets but are aligned with spaces therebetween. Similarly, after a partial rotation of the rotor, if the shaped winding parts of former 10b are aligned with adjacent magnets then the shaped winding parts of formers 10a and 10c are not, and, lastly, when the shaped winding parts of former 10c are aligned with magnets then the shaped winding parts of formers 10a and 10b are not.

FIG. 7 shows a schematic partial view from above adjacent formers 10a, 10b, and 10c with the 3-phase individual live connectors 30a, 30b, and 30c for connection to respective phases of a 3-phase power input, together with common neutral connector 32.

FIG. 8 shows 2 schematic views, a plan view from above and a perspective view of a rotor of the invention on shaft 8, in both cases with additional turns on the windings 24 to show how multiple turns build up the shaped winding parts 25a and 25b on each former.

In use, power from a switched 3-phase DC supply operates the coils successively and when a coil holder's left and right shaped winding parts align with adjacent magnets (which we can refer to here as the left and right magnets), no circumferential directed flux cuts the winding parts and the flux is travelling mainly along the left right direction. Even if current flows in the coil no force is provided. When a coil's winding part is in the gap between magnets the flux is circumferential and normal to the left right direction and cuts the coil such that if current is in the coil a force is provided. Lorentz forces are thus created on the coils (the shaped winding parts), but since these are static, the magnets move and the rotor turns.

When three coil holders are arranged as shown, one coil holder has its coils aligned with and covering the magnets, meanwhile the other two coil holders' coils sit in the section where flux is normal to the left right direction. When the magnets are moved, sometimes the flux direction is inwards circumferentially, and after a certain rotation the same coil has a circumferential flux direction outwards. This is due to the fact the gaps between magnets has SN NS SN NS etc facing.

For wiring the three phases, there are two options: Y and Delta. The Y connection is illustrated in the example, with wires electrically connected as shown in FIG. 7. A 3-phase motor driver electronics speed controller (ESC), such as are commercially available, drives voltages onto the three wires. If we call the three wires R for red, G for Green and B for Blue, then typically the ESC will drive with either a positive voltage, a negative voltage, or no voltage (often described as High Impedance or High Z).

| RED | GREEN | BLUE |
|---|---|---|
| + | High Z | − |
| High Z | + | − |
| − | + | High Z |
| − | High Z | + |
| High Z | − | + |
| + | − | High Z |

Switching occurs in synchronicity with rotor/rotor shaft location. Typically, the shaft position is detected using at least 2 Hall effect sensors or an optical shaft sensor. Alternatively, sensorless ESCs work by estimating shaft angle from the zero crossing of the back EMF detected on the phase that has High Z drive applied. Modern Field Oriented Control ESCs perform more advanced calculations to ensure the current flowing generates the highest torque at all times. The present invention can be used with commonly available types of off-the-shelf ESCs due to the way in which the coils and their shaped parts are wound, forwards and backwards, usually on the formers, combined with the spacing of the coils, i.e. aligned with the spacing of the magnets and their NN SS faces.

As each coil is wound forwards and then backwards, so any current in the coil flows forwards and backwards, and as the forwards coil will be exposed to a circumferential flux zone in one direction and the backwards coil will be exposed to a circumferential flux zone in the opposite direction, so the application of current through the coil results in the same direction of torque when the torque seen on each forwards or backwards coil is summed.

### PARTS LIST

2 magnet
3 through pin
4 rotor
5 rotor body
6 pin mounting
7 magnet holder
8 shaft
10a,b,c formers
11 frusto toroidal inner space, C-section
12 former body
13a,b upper and lower body portions
14a,b curved tubular side arms
16a,b end flanges
18 rotor slot
20a,b upper and lower lugs
21 winding entry channel
22 winding exit channel
24 winding
25a, b shaped winding parts
30a,b,c 3-phase individual live connectors
32 common neutral connector

1. A 3-phase motor comprising:
(i) a rotor comprising four or more magnets arranged in sequence in alternatingly opposed orientation with a pitch at least substantially three times their polar length, wherein the rotor spins about an axis such that the magnets follow a toroidal path; and
(ii) a stator having at least 3 windings, wherein for each winding first and second shaped portions thereof extend substantially transverse to and adjacent to the toroidal path,
wherein
the first and second shaped parts of each winding induce oppositely directed magnetic fields in or around the toroidal path to act on, respectively, the alternatingly opposed adjacent magnets;
the pitch of the first and second shaped parts is substantially the same as the pitch of the magnets;
each of the 3 windings is for connection to a different phase of a 3-phase power supply; and
the 3 windings are staggered around the toroidal path so as to act successively on the magnets.

2. The 3-phase motor of claim 1, wherein the pitch of the magnets is substantially three times their polar length.

3. The 3-phase motor of claim 1, wherein the magnets are permanent, cylindrical magnets.

4. The 3-phase motor of claim 1, wherein the pitch of the first and second shaped winding parts is the same as the pitch of the magnets.

5. The 3-phase motor of claim 1, comprising, for each winding, a coil former to support the first and second shaped parts thereof.

6. The 3-phase motor according to claim 5, wherein the former holds the two shaped parts of the winding relative to the magnets and neighbouring windings.

7. The 3-phase motor of claim 6, wherein each former comprises a body having two side arms and a middle wedge-shaped section and wherein the two shaped winding parts are held on the arms, outside the middle section and within outer flanges.

8. The 3-phase motor of claim 7, wherein the former holds the two shaped parts of the winding relative to the magnets and neighbouring windings such that when the magnets are inside the coil holder then one magnet is covered by/aligned with one winding part of the coil and the adjacent magnet is covered by/aligned with the other winding part of the coil.

9. The 3-phase motor of claim 1, wherein the respective three windings are staggered around the circumference of the rotor such that when the first and second shaped parts of one winding are aligned with adjacent magnets when the first and second shaped parts of the other two windings are not aligned with other magnets.

10. The 3-phase motor of claim 1, comprising more than one stator.

11. The 3-phase motor of claim 10, comprising two stators in phase with each other.

12. The 3-phase motor of claim 10, where in the more than one stators are out-of-phase.

13. A 6-phase motor comprising the 3-phase motor of claim 10.

14. A 9-phase motor comprising the 3-phase motor of claim 10.

15. (canceled)

16. (canceled)

17. (canceled)

18. The 3-phase motor of claim 1, electrically connected to a 3-phase power supply.

19. A drone comprising the 3-phase motor of claim 1.

20. A 3-phase motor comprising:
(i) a rotor comprising four or more permanent, cylindrical magnets arranged in sequence in alternatingly opposed orientation with a pitch at least substantially three times their polar length, wherein the rotor spins about an axis such that the magnets follow a toroidal path; and
(ii) a stator having at least 3 windings, wherein for each winding first and second shaped portions thereof extend substantially transverse to and adjacent to the toroidal path,
wherein
the first and second shaped parts of each winding induce oppositely directed magnetic fields in or around the toroidal path to act on, respectively, the alternatingly opposed adjacent magnets;
the pitch of the magnets is three times their polar length;
the pitch of the first and second shaped parts is the same as the pitch of the magnets;
each of the 3 windings is for connection to a different phase of a 3-phase power supply; and
the 3 windings are staggered around the toroidal path so as to act successively on the magnets.
